(19) United States
(12) Patent Application Publication
(10) Pub. No.: US 2007/0264992 A1
(43) Pub. Date: Nov. 15, 2007

(54) Radio resource control

(75) Inventor: Jani J. Maenpaa, Kangaeala (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/790,912

(22) Filed: Apr. 27, 2007

(30) Foreign Application Priority Data
May 15, 2006 (FI) 20065323

(51) Int. Cl. H04M 3/00

(52) U.S. Cl. 455/420

(57) ABSTRACT

There is provided a radio system including a network element and at least one user terminal supporting MBMS (multimedia broadcast multicast service), the network element being configured to transmit MBMS control information elements from the network element to the user terminal for controlling an MBMS session. The network element comprises: a detection unit for detecting a requirement for more capacity for an MBMS session in the radio system; a processing unit for including an MBMS bearer description in an MBMS control information element to be transmitted to the user terminal, the MBMS bearer description including an assignment to a given MBMS bearer depending on the detected requirement for more capacity; and a transmission unit for performing an MBMS transmission between the network element and the user terminal on the assigned MBMS bearer on the basis of the MBMS bearer description included in the MBMS control information element.

### FIELD

The invention relates to a method of controlling radio resources, to a radio system, to a network element, to a user terminal, to a computer program product, and to a computer program distribution medium.

### BACKGROUND

MBMS (multimedia broadcast multicast service) is a point-to-multipoint capable unidirectional service for transmitting video, audio and other multimedia content from a radio network to multiple recipients at the same time. A multimedia broadcast multicast service bearer is more efficient than a traditional point-to-point transfer in this case. MBMS has two operating modes: a broadcast mode and a multicast mode. The broadcast mode is usually considered to be free of charge and the multicast mode is usually considered to be chargeable depending on subscription. Information about the multimedia broadcast multicast service content can be delivered to the user terminals via p-t-p SMS (short message service), CBCH (cell broadcast channel), WAP (wireless application protocol) push in currently existing methods.

The broadcast mode of the multimedia broadcast multicast service is activated and deactivated locally from the user terminal, i.e. no interaction with the radio network takes place. On the other hand, the activation and deactivation of the multicast mode requires signalling between the user terminal and the network for charging and authentication purposes.

The physical location and description of the MBMS (multimedia broadcast multicast service) bearer is transmitted to the user terminal beforehand in MBMS (pre)notification with a session starting time. Once a timer expires, the user terminal starts listening to the assigned MBMS Packet Data Channels. After the MBMS session is finished, the network will release the radio resources and the user terminal will return to a Common Control Channel (CCCH).

One of the problems of the known solutions used in MBMS is that the radio network has only limited control over dualsystem/IRAT (Inter Radio Access Technology) user terminals supporting MBMS. Currently the user terminals operate according to normal idle mode cell re-selection criteria specified from 3GPP R99 revision onwards during an MBMS reception due to the fact that the MBMS receive mode is considered to be an extension of the idle mode. The radio network has no real control over the user terminals in this case. For example, allocation of radio resources during MBMS sessions is very limited. Thus, there is a need for an improved system where radio resources could be controlled more efficiently.

### BRIEF DESCRIPTION OF THE INVENTION

An object of the invention is to provide an improved method, a user terminal, a radio system, a network element, a computer program product, and a computer program distribution medium. According to a first aspect of the invention, there is provided a method of controlling radio resources in a radio system comprising a network element and at least one user terminal supporting multimedia broadcast multicast service, wherein multimedia broadcast multicast service control information elements are transmitted from the network element to the user terminal for controlling a multimedia broadcast multicast service session. The method comprises: detecting, by the network element, a requirement for more capacity for a multimedia broadcast multicast service session in the radio system; including, by the network element, a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and controlling a multimedia broadcast multicast service transmission between the network element and the user terminal on the assigned multimedia broadcast multicast service bearer on the basis of the multimedia broadcast multicast service bearer description included in the multimedia broadcast multicast service control information element.

According to a second aspect of the invention, there is provided a radio system including a network element and at least one user terminal supporting multimedia broadcast multicast service, the network element being configured to transmit multimedia broadcast multicast service control information elements from the network element to the user terminal for controlling a multimedia broadcast multicast service session. The network element comprises: a detection unit for detecting a requirement for more capacity for a multimedia broadcast multicast service session in the radio system; a processing unit for including a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and a transmission unit for performing a multimedia broadcast multicast service transmission between the network element and the user terminal on the assigned multimedia broadcast multicast service bearer on the basis of the multimedia broadcast multicast service bearer description included in the multimedia broadcast multicast service control information element.

According to a third aspect of the invention, there is provided a network element of a radio system supporting multimedia broadcast multicast service, the network element being configured to transmit multimedia broadcast multicast service control information elements from the network element to the user terminal for controlling a multimedia broadcast multicast service session. The network element comprises: a detection unit for detecting a requirement for more capacity for a multimedia broadcast multicast service session in the radio system; a processing unit for including a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and a transmission unit for performing a multimedia broadcast multicast service transmission to the user terminal on the assigned multimedia broadcast multicast service bearer on the basis of the multimedia broadcast multicast service bearer description included in the multimedia broadcast multicast service control information element.

According to a fourth aspect of the invention, there is provided a user terminal of a radio system supporting multimedia broadcast multicast service, the user terminal comprising a processing unit for controlling functions of the user terminal, and a receiver for receiving multimedia broadcast multicast service control information elements from a network element of the radio system for controlling a multimedia broadcast multicast service session. The receiver is further configured to receive a multimedia broadcast multicast service bearer description in a multimedia broadcast multicast service control information element received from the network element, the multimedia broadcast multicast service bearer description including an assignment to a given multimedia broadcast multicast service bearer depending on the requirement for more capacity detected by the network element; the processing unit is configured to switch to the assigned multimedia broadcast multicast service bearer on the basis of the multimedia broadcast multicast service bearer description included in the multimedia broadcast multicast service control information element; and the receiver is configured to receive a multimedia broadcast multicast service transmission from the network element on the assigned multimedia broadcast multicast service bearer.

According to a fifth aspect of the invention, there is provided a radio system including a network element and at least one user terminal supporting multimedia broadcast multicast service, the network element comprising transmission means for transmitting multimedia broadcast multicast service control information elements from the network element to the user terminal for controlling a multimedia broadcast multicast service session. The network element further comprises: detection means for detecting a requirement for more capacity for a multimedia broadcast multicast service session in the radio system; processing means for including a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and transmission means for performing a multimedia broadcast multicast service transmission between the network element and the user terminal on the assigned multimedia broadcast multicast service bearer on the basis of the multimedia broadcast multicast service bearer description included in the multimedia broadcast multicast service control information element.

According to a sixth aspect of the invention, there is provided a network element of a radio system supporting multimedia broadcast multicast service, the network element comprising transmitting means for transmitting multimedia broadcast multicast service control information elements from the network element to the user terminal for controlling a multimedia broadcast multicast service session. The network element further comprises: detection means for detecting a requirement for more capacity for a multimedia broadcast multicast service session in the radio system; processing means for including a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and transmission means for performing a multimedia broadcast multicast service transmission to the user terminal on the assigned multimedia broadcast multicast service bearer on the basis of the multimedia broadcast multicast service bearer description included in the multimedia broadcast multicast service control information element.

According to a seventh aspect of the invention, there is provided a user terminal of a radio system supporting multimedia broadcast multicast service, the user terminal comprising processing means for controlling functions of the user terminal, and receiving means for receiving multimedia broadcast multicast service control information elements from a network element of the radio system for controlling a multimedia broadcast multicast service session. The receiving means further receive a multimedia broadcast multicast service bearer description in a multimedia broadcast multicast service control information element received from the network element, the multimedia broadcast multicast service bearer description including an assignment to a given multimedia broadcast multicast service bearer depending on the requirement for more capacity detected by the network element; the processing means switch to the assigned multimedia broadcast multicast service bearer on the basis of the multimedia broadcast multicast service bearer description included in the multimedia broadcast multicast service control information element; and the receiving means receive a multimedia broadcast multicast service transmission from the network element on the assigned multimedia broadcast multicast service bearer.

According to yet another aspect of the invention, there is provided a computer program product encoding a computer program of instructions for executing a computer process for controlling radio resources in a radio system comprising a network element and at least one user terminal supporting multimedia broadcast multicast service, and wherein multimedia broadcast multicast service control information elements are transmitted from the network element to the user terminal for controlling a multimedia broadcast multicast service session. The process includes: detecting a requirement for more capacity for a multimedia broadcast multicast service session in the radio system; including a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and controlling a multimedia broadcast multicast service transmission between the network element and the user terminal on the assigned multimedia broadcast multicast service bearer on the basis of the multimedia broadcast multicast service bearer description included in the multimedia broadcast multicast service control information element.

According to yet another aspect of the invention, there is provided a computer program distribution medium readable by a computer and encoding a computer program of instructions for executing a computer process for controlling radio resources in a radio system comprising a network element and at least one user terminal supporting multimedia broadcast multicast service, and wherein multimedia broadcast multicast service control information elements are transmitted from the network element to the user terminal for controlling a multimedia broadcast multicast service session. The process includes: detecting a requirement for more capacity for a multimedia broadcast multicast service session in the radio system; including a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and controlling a multimedia broadcast multicast service transmission between the network element and the user terminal on the assigned multimedia broadcast multicast service bearer on the basis of the multimedia broadcast multicast service bearer description included in the multimedia broadcast multicast service control information element.

As an advantage, the invention enables an effective method to control radio resources in situations related to multimedia broadcast multicast service sessions. A dynamic allocation of multimedia broadcast multicast service bearers is enabled. An efficient control over user equipment supporting multimedia broadcast multicast service becomes possible. The radio resources can be more efficiently controlled depending on network load, coverage boundaries, higher bit rate requirements or ability to receive multiple multimedia broadcast multicast service bearers simultaneously. Further, the multimedia broadcast multicast service reception gaps can be shortened and thus, the service continuation without interruptions visible to users can be achieved.

### LIST OF DRAWINGS

In the following, the invention will be described in greater detail with reference to the embodiments and the accompanying drawings, in which

FIG. 1 shows an example of a radio system;

FIG. 2 shows an example of a network element and a user terminal of a radio system;

FIG. 3 illustrates an example of the method of controlling radio resources; and

FIGS. 4 and 5 are signal sequence diagrams illustrating the method of controlling radio resources.

### DESCRIPTION OF EMBODIMENTS

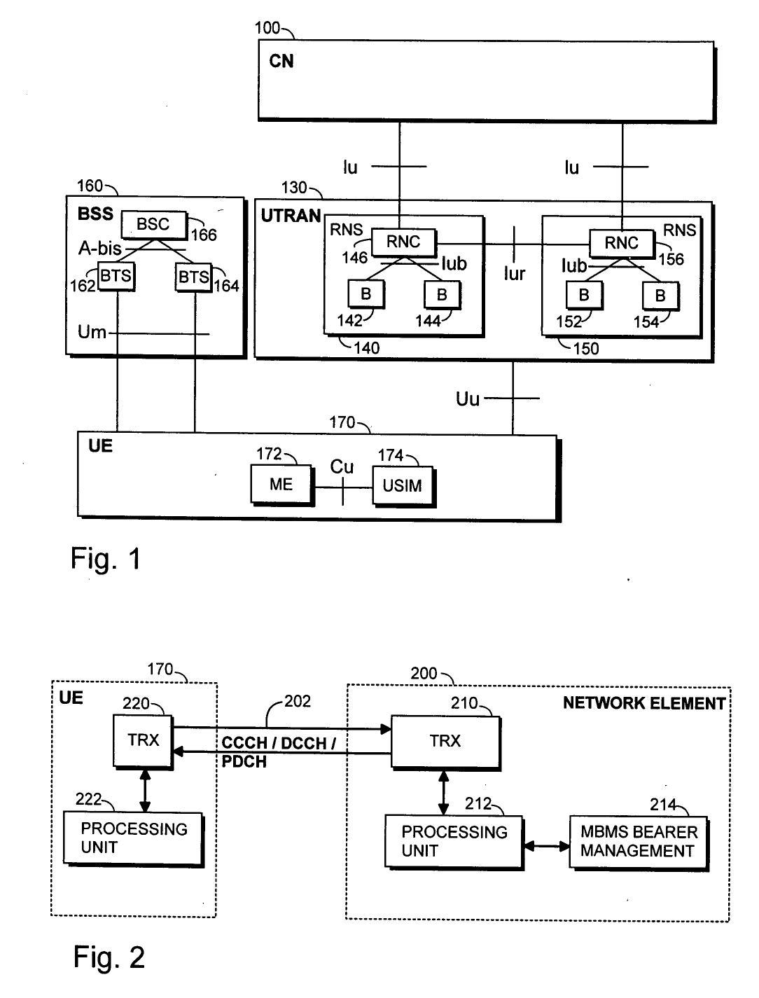

With reference to FIG. 1, examine an example of a radio system in which the preferred embodiments of the invention can be applied. A radio system in FIG. 1, known at least as UMTS (universal mobile telecommunications system) and IMT-2000 (international mobile telecommunications 2000) represents the third-generation radio systems. The embodiments are, however, not restricted to these systems described by way of example, but a person skilled in the art can also apply the instructions to other radio systems containing corresponding characteristics.

FIG. 1 is a simplified block diagram, which shows the most important parts of a radio system and the interfaces between them at network-element level. The structure and functions of the network elements are not described in detail, because they are generally known.

The main parts of a radio system are a core network (CN) 100, a radio access network 130 and a user terminal (UE) 170. The term UTRAN is short for UMTS Terrestrial Radio Access Network, i.e. the radio access net-work 130 belongs to the third generation and is implemented by wideband code division multiple access (WCDMA) technology. FIG. 1 also shows a base station system 160 which belongs to the 2/2.5 generation and is implemented, for example, by time division multiple access (TDMA), general packet radio service (GPRS) or enhanced data rates for global evolution (EDGE) technology.

On a general level, the radio system can also be defined to com-prise user terminal/user equipment, which is also known as a subscriber terminal and mobile phone, for instance, and a network part, which comprises the fixed infrastructure of the radio system, i.e. the core network, radio access network and base station system.

The structure of the core network 100 corresponds to a combined structure of the GSM and GPRS systems. The GSM network elements are responsible for establishing circuit-switched connections, and the GPRS network elements are responsible for establishing packet-switched connections, some of the network elements are, however, in both systems.

The base station system 160 comprises a base station controller (BSC) 166 and base transceiver stations (BTS) 162, 164. The base station controller 166 controls the base transceiver station 162, 164. In principle, the aim is that the devices implementing the radio path and their functions reside in the base transceiver station 162, 164, and control devices reside in the base station controller 166.

The base station controller 166 takes care of the following tasks, for instance: radio resource management of the base transceiver station 162, 164, intercell handovers, frequency control, i.e. frequency allocation to the base transceiver stations 162, 164, management of frequency hopping sequences, time delay measurement on the uplink, implementation of the operation and maintenance interface, and power control.

The base transceiver station 162, 164 contains at least one transceiver, which provides one carrier, i.e. eight time slots, i.e. eight physical channels. The base transceiver station 162, 164 also comprises a transcoder, which converts the speech-coding format used in the radio system to that used in the public switched telephone network and vice versa. In practice, the transcoder is, however, physically located in the mobile services switching centre. The tasks of the base transceiver station 162, 164 include: calculation of timing advance (TA), uplink measurements, channel coding, encryption, decryption, and frequency hopping.

The radio access network 130 is made up of radio network subsystems 140, 150. Each radio network subsystem 140, 150 is made up of radio network controllers 146, 156 and B nodes 142, 144, 152, 154. A B node is a rather abstract concept, and often the term base transceiver station is used instead of it.

Operationally, the radio network controller 146, 156 corresponds approximately to the base station controller 166 of the GSM system, and the B node 142, 144, 152, 154 corresponds approximately to the base transceiver station 162, 164 of the GSM system. Solutions also exist in which the same device is both the base transceiver station and the B node, i.e. said device is capable of implementing both the TDMA and the WCDMA radio interface simultaneously.

Some functions of the radio network controller 146, 156 may be implemented with a digital signal processor, memory, and computer programs for executing computer processes. The basic structure and the operation of the radio network controller 146, 156 are known to one skilled in the art and only the details relevant to the present solution are discussed in detail.

Some functions of the B nodes 142, 144, 152, 154 may be implemented with a digital signal processor, memory, and computer programs for executing computer processes. The basic structure and operation of the base station 142, 144, 152, 154 are known to one skilled in the art and only the details relevant to the present solution are discussed in detail.

The user terminal 170 may comprise mobile equipment (ME) 172 and a UMTS subscriber identity module (USIM) 174. The USIM 174 contains information related to the user and information related to information security in particular, for instance, an encryption algorithm. The user terminal 170 typically includes radio frequency parts (RF) for providing the Uu interface. The user terminal 170 further includes a digital signal processor, memory, and computer programs for executing computer processes. The user terminal 170 may further comprise an antenna, a user interface, and a battery not shown in FIG. 1.

In UMTS networks, the user terminal 170 can be simultaneously connected with a plurality of base transceiver stations (Node B) in occurrence of soft handover.

In UMTS, the most important interfaces between network elements are the Iu interface between the core network and the radio access network, which is divided into the interface IuCS on the circuit-switched side and the interface IuPS on the packet-switched side, and the Uu interface between the radio access network and the user terminal. In GSM, the most important interfaces are the A interface between the base station controller and the mobile services switching centre, the Gb interface between the base station controller and the serving GPRS support node, and the Um interface between the base transceiver station and the user terminal. The interface defines what kind of messages different network elements can use in communicating with each other. The aim is to provide a radio system in which the network elements of different manufacturers interwork so well as to provide an effective radio system. In practice, some of the interfaces are, however, vendor-dependent.

FIG. 2 shows an example of a network element 200 and a user terminal 170 of a radio system. The network element 200 of the radio system can reside in the radio access network 130 and/or in the base station system 160. It may comprise the following elements: one or more transceiver units 210 for communicating, a processing unit 212 for controlling the functions of the network element, and an MBMS bearer management unit 214 that can also be a part of the processing unit 212. The network element 200 and the user terminal 170 support MBMS (multimedia broadcast multicast service) and the network element 200 is configured to transmit MBMS control information elements to the user terminal 170 for controlling an MBMS session.

The user terminal 170 comprises at least a processing unit 222 for controlling functions of the user terminal, and a receiver 220 for receiving MBMS control information elements from a network element 200. The user terminal 170 is a dualsystem/IRAT (inter radio access technology) capable terminal, i.e. capable of handling over from a first radio access technology to a second radio access technology, e.g. from 2G (2^{nd} generation mobile communications) to 3G (3^{rd} generation mobile communications) (e.g. from GPRS to UMTS) and vice versa.

In an embodiment, the network element 200 is configured to detect when more capacity is required for an MBMS (multimedia broadcast multicast service) session in the radio system. A detection unit of the network element 200 that can be a combination of the transceiver unit 210 and the processing unit 212, for example, can perform this detection. More capacity may be needed for an MBMS session, for example, depending on network load, coverage boundaries, bit rate requirements, requirements to receive multiple MBMS bearers simultaneously, or bandwidth requirements.

If the requirement for more capacity for an MBMS (multimedia broadcast multicast service) session is detected, then the MBMS bearer management unit 214 controlled by the processing unit 212 includes an MBMS bearer description in an MBMS control information element to be transmitted to the user terminal 170. The MBMS control information element can be transmitted on CCCH (common control channel), DCCH (associated control channel) or PDCH (packet data channel) channels 202, for example. The MBMS bearer description includes an assignment to a given MBMS bearer depending on the detected requirement for more capacity, and the transceiver unit 210 performs MBMS transmission to the user terminal 170 on the assigned MBMS bearer on the basis of the MBMS bearer description included in the MBMS control information element.

In an embodiment, the receiver 220 of the user terminal 170 is configured to receive the MBMS (multimedia broadcast multicast service) bearer description in the MBMS control information element received from the network element 200, the MBMS bearer description including an assignment to a given MBMS bearer depending on the requirement for more capacity detected by the network element 200. The processing unit 222 of the user terminal 170 is configured to switch to the assigned MBMS bearer on the basis of the MBMS bearer description included in the MBMS control information element, and the receiver 220 is further configured to receive the MBMS transmission from the network element 200 on the assigned MBMS bearer.

In an embodiment where the user terminal 170 is in 2G, the MBMS control information element wherein the MBMS bearer description is included to be transmitted to the user terminal 170 comprises: an MBMS notification, an MBMS assignment, and/or an MBMS announcement message (3GPP (3^{rd} Generation Partnership Project) TS (Technical Specification) 44.018, Chapters 9.1.21j and 9.1.23, 3GPP TS 44.060, Chapters 11.2.39(a), 11.2.42).

The MBMS announcement is a message sent on a main DCCH by the network element 200 to inform the user terminal 170 about a starting MBMS session. The MBMS announcement message may comprise the following information elements: RR manager protocol discriminator, skip indicator, MBMS announcement type, temporary mobile group identity, MBMS counting channel description, MBMS p-t-m channel description, MBMS session parameters list and restriction timer.

The paging request type 2 is a message sent on the CCCH by the network element 200 and it may identify an MBMS session. This message may be sent to the user terminal 170 in 2G idle mode to trigger channel access. It may be sent to the user terminal in packet idle mode to transfer MM (mobility management) information, e.g. trigger a cell update procedure, or to perform an MBMS pre-notification or an MBMS notification. The paging request type 2 message may comprise the following information elements: L2 pseudo length, RR (radio resource) management protocol discriminator, skip indicator, paging request type 2 message type, page mode, mobile identities and P2 rest octets.

The MBMS assignment (distribution) is a message sent on the PCCCH (packet common control channel) or on the CCCH or on the PACCH (packet associated control channel) from the network element 200 to the user terminals 170 in order to assign the radio bearer resources for an MBMS session or to notify the user terminals that a radio bearer for that MBMS session is not established in the cell. The MBMS assignment (distibution) message may comprise the following information elements: page mode, TMGI, MBMS session identity, reject cause, estimated session duration, MBMS in-band signalling indicator, MBMS radio bearer starting time, frequency parameters, downlink timeslot allocation, MBMS bearer identity, EGPRS window size and timeslot allocation uplink feedback channel.

The packet MBMS announcement is a message set on PACCH by the network element 200 to notify all MBMS user terminals 170 listening to that PDCH that an MBMS service is commencing. The packet MBMS announcement message may comprise the following information elements: page mode, TMGI identity, MBMS session identity, estimated session duration, MBMS data transfer starting time, frequency parameters, DL (downlink) timeslot allocation, MBMS bearer identity, EGPRS window size, MPRACH timeslot, USF, MPRACH control parameters and restriction timer.

In the above situation where the user terminal is in a first radio access technology radio system, e.g. in 2G in this example, the network element 200 detects that a need for more capacity than currently is available in the first radio access technology radio system, here in 2^{nd} generation radio system, occurs. Thus, the network element 200 includes an assignment to a second radio access technology, e.g. a 3^{rd} generation in this example, MBMS bearer in the MBMS bearer description that is to be sent to the user terminal 170.

After the user terminal 170 has received the MBMS bearer description from the network element 200, the user terminal 170 switches to the assigned 3^{rd} generation MBMS bearer and starts receiving an MBMS transmission on the assigned 3^{rd} rd generation MBMS bearer.

In an embodiment where the user terminal 170 is in a second radio access technology radio system, e.g. in 3G in this example, the MBMS control information element wherein the MBMS bearer description is included to be transmitted to the user terminal 170 comprises: MBMS access information, MBMS common point-to-multipoint radio bearer information, MBMS current cell point-to-multipoint information, and/or MBMS modified services information (see 3GPP TS 25.331, Chapters 10.2.16e, 10.2.16f, 10.2.16g and 10.2.16j).

The MBMS access Information message is transmitted periodically by UTRAN to inform user terminals that have joined a particular MBMS service about the need to establish an RRC (radio resource control) connection or to perform a cell update. The MBMS access information message may comprise the following information elements: message type, service list, MBMS short transmission ID (identity), access probability factor for user terminals in idle mode, access probability factor for user terminals in connected mode, connected mode counting scope.

The MBMS common p-t-m RB Information message is transmitted periodically by UTRAN to inform user terminals about the p-t-m RB (radio bearer) configuration information that may be common between different services, applicable in the current and/or neighbouring cells. The MBMS common p-t-m radio bearer Information message may comprise the following information elements: message type, RB information list, RB identity, PDCP (packet data convergence protocol) info, RLC (radio link control) info, TrCh (transport channel) information for each TrCh, transport channel identity, TFS (transport format combination), TrCh information for each CCTrCh (coded composite transport channel), CCTrCH identity, TFCS (transport format combination set), PhyCh (physical channel) information, PhyCh identity and Secondary CCPCH (common control physical channel) info MBMS.

The MBMS current cell p-t-m RB Information message is transmitted periodically by UTRAN to inform user terminals about the PTM (point-to-multipoint) RB configuration used in a cell, in case one or more MBMS services are provided using p-t-m radio bearers. The MBMS current cell p-t-m RB information message may comprise the following information elements: message type, S-CCPCH (secondary common control physical channel) list, S-CCPCH identity, secondary CCPCH info, MBMS soft combining timing Offset, TrCh information common for all TrChs, TrCH information list, TrCh information, RB information list, RB information, MSCH configuration information, S-CCPCH in SIB type 5, S-CCPCH identity, TrCH information list and TrCh identity.

The MBMS Modified Services Information is transmitted periodically by UTRAN to inform user terminals about a change applicable to one or more MBMS services available in the current cell and possibly in neighbouring cells. The MBMS modified services information may comprise the following information elements: message type, modified service list, MBMS transmission identity, MBMS required user terminal action, MBMS preferred frequency, MBMS dispersion indicator, continue MCCH reading, MBMS re-acquire MCCH, MBMS dynamic persistence level, end of modified MCCH information, MBMS number of neighbour cells, MBMS all unmodified p-t-m services and MBMS p-t-m activation time.

In the above situation where the user terminal is in 3G, the network element 200 detects that a need for more capacity than currently is available in a 3^{rd} generation radio system occurs. Thus, the network element 200 includes an assignment to a 2^{nd} generation MBMS bearer in the MBMS bearer description that is to be sent to the user terminal 170.

After the user terminal 170 has received the MBMS bearer description from the network element 200, the user terminal 170 switches to the assigned 2^{nd} generation MBMS bearer and starts receiving an MBMS transmission on the assigned 2^{nd} nd generation MBMS bearer.

Thus, the radio network according to embodiments of the invention can assign MBMS bearer(s) to a user terminal from 2G to 3G and vice versa. This also gives more flexibility for operators to utilize radio resources in 3G and 2G more efficiently, e.g. by moving MBMS user terminals away from high load channels.

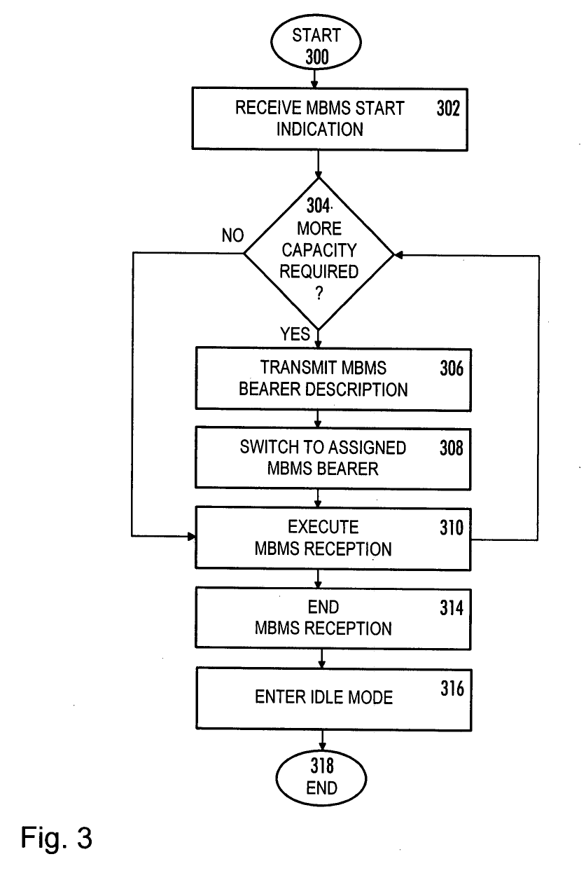

With reference to FIG. 3, an example of methodology according to the embodiments of the invention is shown in a flow chart.

In FIG. 3, the method starts in 300.

In 302, an MBMS (multimedia broadcast multicast service) start indication is received.

If, in 304, it is detected that more capacity is required in the starting MBMS session, then 306 is entered. Otherwise, 310 is entered.

In 306, an MBMS bearer description is transmitted to the user terminal in an MBMS control information element. The MBMS bearer description includes an assignment to a given MBMS bearer depending on the detected requirement for more capacity.

In 308, the user terminal switches to the assigned MBMS bearer.

In 310, MBMS transmission is executed on the assigned MBMS bearer on the basis of the MBMS bearer description included in the MBMS control information element.

If during the MBMS transmission, in 304, it is detected that more capacity is required, 306 is entered again.

In 314, an end of the MBMS reception takes place.

In 316, the user terminal starts behaving according to the idle mode cell re-selection rules.

The method ends in 318.

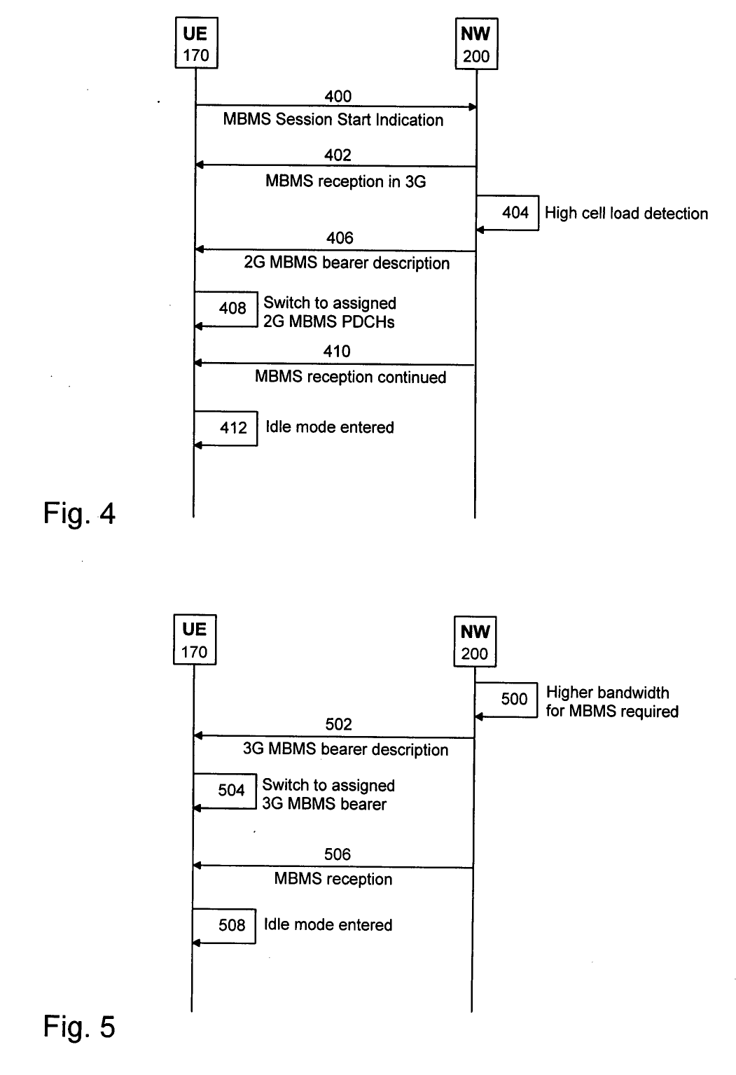

FIGS. 4 and 5 are signal sequence diagrams illustrating the method of controlling radio resources.

In FIG. 4, at first the user terminal 170 is in a second radio access technology radio system mode, e.g. in 3G/3.9G/EUTRAN (Enhanced universal terrestrial radio access network) mode. In 400, an MBMS session start indication is sent to the network 200 from the user terminal 170. A user may have subscribed a multicast service for low bandwidth audio clips (interviews etc.) and pictures of e.g. Cannes Film Festival. When the session starting time has lapsed, the user terminal starts receiving an MBMS transmission in the second radio access technology, e.g. in 3G/3.9G in 402. Broadcasting of high bandwidth video/TV stream commences in the same 3G/3.9G cell(s). The network may then decide to move Multicast reception to a first radio access technology system, e.g. to 2G or GERAN (GSM/EDGE radio access network). In 404, the network 200 detects that the cell load is getting high due to CS (circuit switched) and PS (packet switched) traffic, for example. In 406, the network 200 sends a first radio access technology MBMS bearer description, such as 2G MBMS bearer description or an EUTRAN MBMS control message with a GERAN MBMS bearer description, to the user terminal 170. The MBMS bearer description can be sent, for example, with MBMS modified services Information to the user terminal 170.

In 408, the user terminal 170 switches to the assigned 2G MBMS PDCHs or to GERAN MBMS carrier to continue low bandwidth MBMS reception. In 410, the MBMS reception is continued. When the MBMS reception is finished, 412 is entered where the user terminal behaves according to idle mode cell re-selection rules or camps to EUTRAN CCCH (common control channel), for example. If MBMS reception fails in the first radio access technology carrier, such as in a GERAN carrier, the user terminal may return to previous second radio access technology carrier, such as to a 3.9G carrier, and transmit a reception failure indication. The network may or may not retransmit a MBMS control message or a point-to-point bearer message.

In FIG. 5, at first the user terminal 170 is in a first radio access technology radio system mode, e.g. in 2G or GERAN idle mode in this example. In 500 it is detected that a higher bandwidth than is currently available in the 2G/GERAN side is required in MBMS transmission (not enough PDCHs available/higher bandwidth/TV broadcast). In 502, the network 200 sends an MBMS session notification (with a starting time) with a second radio access technology MBMS bearer description, such as 3G/3.9G/EUTRAN MBMS bearer description in this example, to the user terminal 170.

In 504, the user terminal 170 switches to the assigned second radio access technology MBMS bearer, e.g. to 3G/3.9G/EUTRAN MBMS bearer, just before the starting time has elapsed. In 506, the MBMS reception commences. When the MBMS reception ends in 508, the user terminal 170 behaves according to idle mode cell re-selection rules. If MBMS reception fails in the second radio access technology carrier, such as in EUTRAN carrier, the user terminal may return to previous 2G/GERAN carrier and transmit reception failure indication. The network may or may not retransmit MBMS control message or point-to-point bearer message.

In an embodiment, as the user terminals are considered to be in an idle mode during MBMS reception, it is possible that passing of location area/routing area boundary/tracking area boundary does not require any signalling procedures, thus enabling the user terminals to directly continue MBMS reception.

In an aspect, the invention provides a computer program product encoding a computer program of instructions for executing a computer process for process for controlling radio resources in a radio system comprising a network element and at least one user terminal supporting MBMS (multimedia broadcast multicast service), and wherein MBMS control information elements are transmitted from the network element to the user terminal for controlling an MBMS session.

In another aspect, the invention provides a computer program distribution medium readable by a computer and encoding a computer program of instructions for executing a computer process for controlling radio resources in a radio system comprising a network element and at least one user terminal supporting MBMS (multimedia broadcast multicast service), and wherein MBMS control information elements are transmitted from the network element to the user terminal for controlling an MBMS session.

The distribution medium may include a computer readable medium, a program storage medium, a record medium, a computer readable memory, a computer readable software distribution package, a computer readable signal, a computer readable telecommunications signal, and/or a computer readable compressed software package.

Embodiments of the computer process are shown and described in conjunction with FIGS. 3, 4 and 5.

The computer program may be executed in the processing unit 212 of the network element 200. Some process steps may be executed in the digital signal processor 222 of the user terminal 170. Some process steps may be executed, depending on the embodiment, in the digital signal processor of the radio network controller 146,156 or the base station controller 166.

Even though the invention has been disclosed above with reference to an example according to the accompanying drawings, it is clear that the invention is not restricted thereto but can be modified in several ways within the scope of the appended claims.

1. A method, comprising:
controlling radio resources in a radio system comprising a network element and at least one user terminal supporting multimedia broadcast multicast service,
transmitting multimedia broadcast multicast service control information elements from the network element to the user terminal for controlling a multimedia broadcast multicast service session,
detecting, by the network element, a requirement for more capacity for the multimedia broadcast multicast service session in the radio system;
including, by the network element, a multimedia broadcast multicast service bearer description in a multimedia broadcast multicast service control information element to be transmitted to the user terminal,
including, by the network element, an assignment to a given multimedia broadcast multicast service bearer depending on the detected requirement for more capacity in the multimedia broadcast multicast service bearer description; and
controlling a multimedia broadcast multicast service transmission between the network element and the user terminal on the assigned multimedia broadcast multicast service bearer based on the multimedia broadcast multicast service bearer description included in the multimedia broadcast multicast service control information element.

2. The method of claim 1, wherein the multimedia broadcast multicast service control information element comprises at least one of a multimedia broadcast multicast service notification, a multimedia broadcast multicast service assignment, or a multimedia broadcast multicast service announcement message.

3. The method of claim 1, wherein the detecting the requirement for more capacity for the multimedia broadcast multicast service session comprises detecting a need for more capacity than is currently available in a first radio access technology radio system when the user terminal is in a first radio access technology idle mode, and including an assignment to a second radio access technology multimedia broadcast multicast service bearer in the multimedia broadcast multicast service bearer description.

4. The method of claim 3, wherein the controlling the multimedia broadcast multicast service transmission comprises switching, by the user terminal, to the assigned second radio access technology multimedia broadcast multicast service bearer once the multimedia broadcast multicast service bearer description is received from the network element, and commencing a multimedia broadcast multicast service transmission between the network element and the user terminal on the assigned second radio access technology multimedia broadcast multicast service bearer.

5. The method of claim 1, wherein the multimedia broadcast multicast service control information element comprises at least one of multimedia broadcast multicast service access information, multimedia broadcast multicast service common point-to-multipoint radio bearer information, multimedia broadcast multicast service current cell point-to-multipoint information, or multimedia broadcast multicast service modified services information.

6. The method of claim 1, wherein the detecting the requirement for more capacity for the multimedia broadcast multicast service session comprises detecting a need for more capacity than is currently available in a second radio access technology radio system when the user terminal is receiving a multimedia broadcast multicast service transmission on a second radio access technology multimedia broadcast multicast service bearer, and including an assignment to a first radio access technology multimedia broadcast multicast service bearer in the multimedia broadcast multicast service bearer description.

7. The method of claim 6, wherein the controlling the multimedia broadcast multicast service transmission comprises switching, by the user terminal, to the assigned first radio access technology multimedia broadcast multicast service bearer once the multimedia broadcast multicast service bearer description is received from the network element, and continuing a multimedia broadcast multicast service transmission between the network element and the user terminal on the assigned first radio access technology multimedia broadcast multicast service bearer.

8. A radio system, comprising:
a network element; and
at least one user terminal supporting multimedia broadcast multicast service,
wherein the network element is configured to transmit multimedia broadcast multicast service control information elements from the network element to the user terminal to control a multimedia broadcast multicast service session,
wherein the network element comprises
a detection unit configured to detect a requirement for more capacity for the multimedia broadcast multicast service session in the radio system,
a processing unit configured to include a multimedia broadcast multicast service bearer description in a multimedia broadcast multicast service control information element to be transmitted to the user terminal, and to include an assignment to a given multimedia broadcast multicast service bearer depending on the detected requirement for more capacity in the multimedia broadcast multicast service bearer description, and
a transmission unit for performing a multimedia broadcast multicast service transmission between the network element and the user terminal on the assigned multimedia broadcast multicast service bearer based on the multimedia broadcast multicast service bearer description included in the multimedia broadcast multicast service control information element.

9. The radio system of claim 8, wherein the multimedia broadcast multicast service control information element comprises at least one of a multimedia broadcast multicast service notification, a multimedia broadcast multicast service assignment, or a multimedia broadcast multicast service announcement message.

10. The radio system of claim 8, wherein the detection unit is configured to detect a need for more capacity than is currently available in a first radio access technology radio system when the user terminal is in a first radio access technology idle mode, and wherein the processing unit is configured to include an assignment to a second radio access technology multimedia broadcast multicast service bearer in the multimedia broadcast multicast service bearer description.

11. The radio system of claim 8, wherein the multimedia broadcast multicast service control information element comprises at least one of multimedia broadcast multicast service access information, multimedia broadcast multicast service common point-to-multipoint radio bearer information, multimedia broadcast multicast service current cell point-to-multipoint information, or multimedia broadcast multicast service modified services information.

12. The radio system of claim 8, wherein the detection unit is configured to detect a need for more capacity than is currently available in a second radio access technology radio system when the user terminal is receiving a multimedia broadcast multicast service transmission on a second radio access technology multimedia broadcast multicast service bearer, and wherein the processing unit is configured to include an assignment to a first radio access technology multimedia broadcast multicast service bearer in the multimedia broadcast multicast service bearer description.

13. A network element of a radio system supporting multimedia broadcast multicast service, wherein the network element comprises:
a detection unit configured to detect a requirement for more capacity for a multimedia broadcast multicast service session in the radio system;
a processing unit configured to include a multimedia broadcast multicast service bearer description in a multimedia broadcast multicast service control information element to be transmitted to the user terminal, the multimedia broadcast multicast service bearer description including an assignment to a given multimedia broadcast multicast service bearer depending on the detected requirement for more capacity; and
a transmission unit configured to perform a multimedia broadcast multicast service transmission to the user terminal on the assigned multimedia broadcast multicast service bearer based on the multimedia broadcast multicast service bearer description included in the multimedia broadcast multicast service control information element,
wherein the network element is configured to transmit multimedia broadcast multicast service control information elements from the network element to the user terminal for controlling the multimedia broadcast multicast service session.

14. The network element of claim 13, wherein the multimedia broadcast multicast service control information element comprises at least one of a multimedia broadcast multicast service notification, a multimedia broadcast multicast service assignment, or a multimedia broadcast multicast service announcement message.

15. The network element of claim 13, wherein the detection unit is configured to detect a need for more capacity than is currently available in a first radio access technology radio system when the user terminal is in a first radio access technology idle mode, and wherein processing unit is configured to include an assignment to a second radio access technology multimedia broadcast multicast service bearer in the multimedia broadcast multicast service bearer description.

16. The network element of claim 13, wherein the multimedia broadcast multicast service control information element comprises at least one of multimedia broadcast multicast service access information, multimedia broadcast multicast service common point-to-multipoint radio bearer information, multimedia broadcast multicast service current cell point-to-multipoint information, or multimedia broadcast multicast service modified services information.

17. The network element of claim 13, wherein the detection unit is configured to detect a need for more capacity than is currently available in a second radio access technology radio system when the user terminal is receiving a multimedia broadcast multicast service transmission on a second radio access technology multimedia broadcast multicast service bearer, and wherein the processing unit is configured to include an assignment to a first radio access technology multimedia broadcast multicast service bearer in the multimedia broadcast multicast service bearer description.

18. A user terminal of a radio system supporting multimedia broadcast multicast service, the user terminal comprising:
a processing unit configured to control functions of the user terminal; and
a receiver configured to receive multimedia broadcast multicast service control information elements from a network element of the radio system for controlling a multimedia broadcast multicast service session,
wherein the receiver is further configured to receive a multimedia broadcast multicast service bearer description in the multimedia broadcast multicast service control information element received from the network element,
wherein the multimedia broadcast multicast service bearer description includes an assignment to a given multimedia broadcast multicast service bearer depending on the requirement for more capacity detected by the network element;
wherein the processing unit is configured to switch to the assigned multimedia broadcast multicast service bearer based on the multimedia broadcast multicast service bearer description included in the multimedia broadcast multicast service control information element; and
wherein the receiver is additionally configured to receive a multimedia broadcast multicast service transmission from the network element on the assigned multimedia broadcast multicast service bearer.

19. The user terminal of claim 18, wherein the multimedia broadcast multicast service control information element comprises at least one of a multimedia broadcast multicast service notification, a multimedia broadcast multicast service assignment, or a multimedia broadcast multicast service announcement message.

20. The user terminal of claim 18, wherein the multimedia broadcast multicast service bearer description includes an assignment to a second radio access technology multimedia broadcast multicast service bearer when the user terminal is in a first radio access technology idle mode, and the processing unit is configured to switch to the second radio access technology multimedia broadcast multicast service bearer when the assignment to the second radio access technology multimedia broadcast multicast service bearer is received.

21. The user terminal of claim 18, wherein the multimedia broadcast multicast service control information element comprises at least one of multimedia broadcast multicast service access information, multimedia broadcast multicast service common point-to-multipoint radio bearer information, multimedia broadcast multicast service current cell point-to-multipoint information, or multimedia broadcast multicast service modified services information.

22. The user terminal of claim 18, wherein the multimedia broadcast multicast service bearer description includes an assignment to a first radio access technology multimedia broadcast multicast service bearer when the user terminal is receiving a multimedia broadcast multicast service transmission on a second radio access technology multimedia broadcast multicast service bearer, and the processing unit is configured to switch to the first radio access technology multimedia broadcast multicast service bearer when the assignment to the first radio access technology multimedia broadcast multicast service bearer is received.

23. A computer program product embodied on a computer-readable medium encoding a computer program of instructions for executing a computer process, the process comprising:
controlling radio resources in a radio system comprising a network element and at least one user terminal supporting multimedia broadcast multicast service, and wherein multimedia broadcast multicast service control information elements are transmitted from the network element to the user terminal for controlling a multimedia broadcast multicast service session;
detecting a requirement for more capacity for the multimedia broadcast multicast service session in the radio system;
including a multimedia broadcast multicast service bearer description in a multimedia broadcast multicast service control information element to be transmitted to the user terminal,
including an assignment to a given multimedia broadcast multicast service bearer depending on the detected requirement for more capacity in the multimedia broadcast multicast service bearer description; and
controlling a multimedia broadcast multicast service transmission between the network element and the user terminal on the assigned multimedia broadcast multicast service bearer based on the multimedia broadcast multicast service bearer description included in the multimedia broadcast multicast service control information element.

24. The computer program product of claim 23, the process further comprising:
detecting a need for more capacity than is currently available in a first radio access technology radio system when the user terminal is in a first radio access technology idle mode; and
including an assignment to a second radio access technology multimedia broadcast multicast service bearer in the multimedia broadcast multicast service bearer description.

25. The computer program product of claim 23, the process further comprising:
detecting a need for more capacity than is currently available in a second radio access technology radio system when the user terminal is receiving a multimedia broadcast multicast service transmission on a second radio access technology multimedia broadcast multicast service bearer; and
including an assignment to a first radio access technology multimedia broadcast multicast service bearer in the multimedia broadcast multicast service bearer description.

26. A computer program distribution medium readable by a computer and encoding a computer program of instructions for executing a computer process, the process comprising:
controlling radio resources in a radio system comprising a network element and at least one user terminal supporting multimedia broadcast multicast service, wherein multimedia broadcast multicast service control information elements are transmitted from the network element to the user terminal to control a multimedia broadcast multicast service session;
detecting a requirement for more capacity for the multimedia broadcast multicast service session in the radio system;
including a multimedia broadcast multicast service bearer description in a multimedia broadcast multicast service control information element to be transmitted to the user terminal;
including an assignment to a given multimedia broadcast multicast service bearer depending on the detected requirement for more capacity in the multimedia broadcast multicast service bearer description; and
controlling a multimedia broadcast multicast service transmission between the network element and the user terminal on the assigned multimedia broadcast multicast service bearer based on the multimedia broadcast multicast service bearer description included in the multimedia broadcast multicast service control information element.

27. The computer program distribution medium of claim 26, the distribution medium comprising at least one of a computer readable medium, a program storage medium, a record medium, a computer readable memory, a computer readable software distribution package, a computer readable signal, a computer readable telecommunications signal, or a computer readable compressed software package.
